(19) United States
(12) Patent Application Publication
(10) Pub. No.: US 2024/0184848 A1
(43) Pub. Date: Jun. 6, 2024

(54) MEMORY ALLOCATION METHOD FOR SPARSE MATRIX MULTIPLICATION APPLICATIONS

(71) Applicant: Alibaba (China) Co., Ltd., Hangzhou (CN)

(72) Inventors: Zhaoyang DU, Hangzhou (CN); Yijin GUAN, Beijing (CN); Dimin NIU, Sunnyvale, CA (US); Tianchan GUAN, Shanghai (CN); Hongzhong ZHENG, Los Gatos, CA (US)

(21) Appl. No.: 18/309,826

(22) Filed: Apr. 30, 2023

(30) Foreign Application Priority Data
Dec. 2, 2022 (CN) 202211535033.7

(51) Int. Cl. G06F 17/16; G06F 7/487

(52) U.S. Cl. CPC G06F 17/16; G06F 7/4876

(57) ABSTRACT

This application describes accelerator, computer system, and method for memory allocation in sparse matrix-matrix multiplications (spGEMM). An example method may include: computing a number of floating point multiplication operations (FLOP) to be performed to generate each row in the output matrix; determining an estimated compression ratio based on a plurality of first rows sampled from the first sparse matrix and a plurality of corresponding second rows from the second sparse matrix; determining an estimated number of non-zero data (NNZ) in each row of the to-be-generated output matrix; constructing a plurality of hash tables for the rows in the to-be-generated output matrix based on the estimated NNZ corresponding to each row; performing symbolic computations between the first and second sparse matrices by using the hash tables to determine actual NNZs in the to-be-generated output matrix; and allocating a memory space for the output matrix based on the actual NNZs.

### CROSS REFERENCE TO RELATED APPLICATION

This application claims priority to and benefits of Chinese patent Application No. 202211535033.7, filed with the China National Intellectual Property Administration (CNIPA) on Dec. 2, 2022. The entire contents of the above-identified application are incorporated herein by reference.

### TECHNICAL FIELD

The disclosure relates generally to efficient memory allocation for sparse matrix multiplications.

### BACKGROUND

General Sparse Matrix-Matrix Multiplication (spGEMM) has attracted much attention from researchers in the fields of multigrid methods and graph analysis. Many real-world applications involve performing spGEMM on sparse matrices. For example, the publicly available SuiteSparse Matrix Collection is a large and actively growing set of sparse matrices that arise from a wide spectrum of domains, such as semiconductor devices, computer graphics and vision, robotics, and kinematics, quantum chemistry, chemical process simulation, and so on.

In computer technologies, sparse matrices are usually stored in a compact format to improve the memory/storage efficiency, such as using Coordinate list (COO), Compressed Sparse Row (CSR), bitmap format, etc. The size of the compact data structure is closely related to the number of non-zero values in the matrix. When generating a new sparse matrix (e.g., as a result of spGEMM operation), allocating a right-size memory space to store the new sparse matrix in the compact data structure is critical for memory efficiency. However, it is difficult to predict the accurate size of the output matrix (e.g., the number of non-zero values) before actually performing the matrix multiplication.

### SUMMARY

Various embodiments of the present specification may include hardware circuitries, systems, methods for efficient memory allocation for sparse matrix multiplications.

In some aspects, the techniques described herein relate to a computer-implemented method for memory allocation in performing sparse matrix-matrix multiplications (spGEMM) between a first sparse matrix and a second sparse matrix to generate an output matrix, including: computing a number of floating point multiplication operations (FLOP) corresponding to each row of a to-be-generated output matrix, wherein the FLOP indicates a number of computations to be performed between each row in the first sparse matrix and one or more corresponding rows in the second sparse matrix to obtain a row in the to-be-generated output matrix, and each row in the first sparse matrix and each row in the to-be-generated output matrix have one-to-one correspondence; determining an estimated compression ratio of the to-be-generated output matrix based on a plurality of first rows sampled from the first sparse matrix and a plurality of corresponding second rows from the second sparse matrix; determining an estimated number of non-zero data (NNZ) in each row of the to-be-generated output matrix based on the FLOPs and the estimated compression ratio; constructing a hash table for each row in the to-be-generated output matrix based on the estimated NNZ corresponding to the row; performing symbolic computations between the first sparse matrix and the second sparse matrix by using the hash tables to determine actual NNZs in the to-be-generated output matrix; and allocating a memory space in preparation for storing the to-be-generated output matrix based on the actual NNZs.

In some aspects, the FLOP indicates a number of multiplication operations to be performed to generate each row in the to-be-generated output matrix, and wherein the estimated compression ratio of the to-be-generated output matrix is determined by a ratio between the precise FLOPs and the precise NNZs of rows in the to-be-generated output matrix.

In some aspects, the computer-implemented method may further include: performing numeric computations based on non-zero data in the first sparse matrix and the second sparse matrix to obtain output data; and storing the output data in the allocated memory space.

In some aspects, the performing symbolic computations between the first sparse matrix and the second sparse matrix to determine the actual NNZ per output row using the hash tables comprises: grouping rows of the first sparse matrix into a plurality of row groups based on the estimated NNZs of the corresponding rows in the to-be-generated output matrix; constructing a plurality of kernels respectively for the plurality of row groups; and for each of the plurality of row groups, performing, using the kernel, symbolic computation using the hash tables to determine the actual NNZs in the to-be-generated output matrix.

In some aspects, the kernels for different row groups are optimized differently according to the estimated NNZs of the output rows corresponding to the rows in the different row groups.

In some aspects, the determining the estimated compression ratio for the first sparse matrix comprises: performing symbolic computation on each of the plurality of sampled first rows and one or more corresponding second rows in the second sparse matrix to obtain total NNZs, referred to as the sampled NNZs; and determining the estimated compression ratio based on the total FLOPs of output rows corresponding to the plurality of sampled first rows, referred to as the sampled FLOPs, and the sampled NNZs.

In some aspects, the constructing the hash table for each row in the to-be-generated output matrix based on the estimated NNZ comprises: applying a floating scale factor greater than one to the estimated NNZ to obtain a scaled-up memory size; allocating a first memory space based on the scaled-up memory size; and constructing the hash table using the first memory space.

In some aspects, the performing symbolic computation to determine the actual NNZs in the to-be-generated output matrix comprises: for a row in the row group, determining a failure threshold; detecting that the symbolic computation on the row generates a number of non-zero data greater than the failure threshold; and raising an exception comprising an index of the row, wherein the exception triggers an error handling procedure.

In some aspects, the error handling procedure includes: removing, based on the index of the row, the row from the row group and adding the row to a next group corresponding to greater estimated NNZs.

In some aspects, the constructing the hash table to determine the actual NNZs in the to-be-generated output matrix comprises: grouping the rows in the first sparse matrix into the plurality of row groups, for rows in a same row group, obtaining the estimated NNZs of the corresponding rows in the to-be-generated output matrix; determining a largest estimated NNZ in the estimated NNZs; allocating a first memory space based on the largest estimated NNZ corresponding to each row in the same row group; and constructing the hash tables for the corresponding rows in the to-be-generated output matrix row using the allocated first memory spaces.

In some aspects, the first memory spaces corresponding to rows in a last row group are allocated from a global memory of a graphic processing unit (GPU), and the first memory spaces corresponding to rows other than the last row group are allocated from a shared memory of the GPU.

In some aspects, the kernel includes a function executable by a GPU.

In some aspects, the techniques described herein relate to an sparse matrix-matrix multiplications (spGEMM) accelerator for allocating memory space to store an output matrix of sparse matrix-matrix multiplications (spGEMM) between a first sparse matrix and a second sparse matrix, including: a row-wise NNZ (a number of non-zero data in each row) estimation circuit, configured to: compute a number of floating point multiplication operations (FLOP) corresponding to each row of a to-be-generated output matrix, wherein the FLOP indicates a number of computations to be performed between each row in the first sparse matrix and one or more corresponding rows in the second sparse matrix to obtain a row in the to-be-generated output matrix, and each row in the first sparse matrix and each row in the to-be-generated output matrix have one-to-one correspondence; determine an estimated compression ratio of the to-be-generated output matrix based on a plurality of first rows sampled from the first sparse matrix and a plurality of second rows from the second sparse matrix corresponding to the plurality of first rows; determining an estimated number of non-zero data (NNZ) in each row of the to-be-generated output matrix based on the FLOPs and the estimated compression ratio; a hash-table memory allocation circuit, configured to: construct a hash table for each row in the to-be-generated output matrix based on the estimated NNZ corresponding to the row; a kernel construction circuit, configured to: group rows in the first sparse matrix into a plurality of row groups based on the estimated NNZs of the corresponding rows in the to-be-generated output matrix; construct a plurality of kernels respectively for the plurality of row groups according to the estimated NNZs corresponding to the rows in each of the plurality of row groups; for each of the plurality of row groups, perform, using the kernel, symbolic computation using the hash tables to determine the actual NNZs in the to-be-generated output matrix; and an output matrix memory allocation circuit, configured to: allocate a memory space for storing the to-be-generated output matrix based on the actual NNZs.

In some aspects, the techniques described herein relate to a non-transitory computer-readable storage medium for allocating memory space to store an output matrix of sparse matrix-matrix multiplications (spGEMM) between a first sparse matrix and a second sparse matrix, the storage medium storing instructions that, when executed by one or more processors, cause the one or more processors to perform operations including: computing a number of floating point multiplication operations (FLOP) corresponding to each row of a to-be-generated output matrix, wherein the FLOP indicates a number of computations to be performed between each row in the first sparse matrix and one or more corresponding rows in the second sparse matrix to obtain a row in the to-be-generated output matrix, and each row in the first sparse matrix and each row in the to-be-generated output matrix have one-to-one correspondence; determining an estimated compression ratio of the to-be-generated output matrix based on a plurality of first rows sampled from the first sparse matrix and a plurality of second rows from the second sparse matrix corresponding to the plurality of first rows; determining an estimated number of non-zero data (NNZ) in each row of the to-be-generated output matrix based on the FLOPs and the estimated compression ratio; constructing a hash table for each row in the to-be-generated output matrix based on the estimated NNZ corresponding to the row; performing symbolic computations between the first sparse matrix and the second sparse matrix by using the hash tables to determine actual NNZs in the to-be-generated output matrix; and allocating a memory space in preparation for storing the to-be-generated output matrix based on the actual NNZs.

These and other features of the systems, methods, and hardware devices disclosed, and the methods of operation and functions of the related elements of structure and the combination of parts and economics of manufacture will become more apparent upon consideration of the following description and the appended claims referring to the drawings, which form a part of this specification, where like reference numerals designate corresponding parts in the figures. It is to be understood, however, that the drawings are for illustration and description only and are not intended as a definition of the limits of the invention.

### BRIEF DESCRIPTION OF THE DRAWINGS

FIG. 1 illustrates an exemplary schematic diagram of a hardware environment for implementing efficient memory allocation for spGEMM (General Sparse matrix-matrix Multiplication) in accordance with some embodiments.

FIG. 2 illustrates an exemplary row-wise approach for executing spGEMM with efficient memory allocation in accordance with some embodiments.

FIG. 3A illustrates an exemplary block diagram of efficient memory allocation for spGEMM in accordance with some embodiments.

FIG. 3B illustrates two different symbolic multiplication operations for estimating compression ratio in accordance with some embodiments.

FIG. 4 illustrates an exemplary diagram for constructing kernels and allocating hash tables in computing the memory size for storing the output matrix of the spGEMM in accordance with some embodiments.

FIG. 5 illustrates an exemplary error handling procedure in computing the output matrix size of the spGEMM in accordance with some embodiments.

FIG. 6 illustrates an exemplary method of efficient memory allocation for spGEMM in accordance with some embodiments.

FIG. 7 illustrates an exemplary block diagram of a hardware device implementing efficient memory allocation for spGEMM in accordance with some embodiments.

### DETAILED DESCRIPTION

The specification is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present specification. Thus, the specification is not limited to the embodiments shown but is to be accorded the widest scope consistent with the principles and features disclosed herein.

In sparse matrices, typically, the number of non-zero (NNZ) elements is much smaller than the number of zero elements. When storing sparse matrices in computer systems, compact data structures are often used to save the memory footprint of the matrices. These data structures may include Coordinate list (COO), Compressed Sparse Row (CSR), bit map, etc. General sparse matrix-matrix multiplication (spGEMM), involving multiplying two sparse matrices, is a fundamental and expensive computational kernel in numerous scientific computing applications and graph algorithms, such as algebraic multigrid solvers, triangle counting, multi-source breadth-first searching, and so on.

There are several challenging problems associated with optimizing the execution of spGEMM on computer systems, one of which is the unknown number of non-zeros in the output matrix of the spGEMM. An accurate estimation of the number of non-zeros in the output matrix is critical for efficiently managing hardware resources, in particular, pre-allocating memory spaces for the output matrix before actually performing the numerical multiplications, with the capability of minimizing the cost of over-allocation and under-allocation. For instance, excessively over-allocated memory space may cause memory waste and overall system pressure, and under-allocated memory space may lead to a large number of expensive dynamic memory allocations for the generated non-zero elements.

There are several solutions for estimating the number of non-zeros of the output matrix in spGEMM involving two input sparse matrices. For example, a precise method determines the actual size of the output. The precise method typically includes two phases: symbolic phase and numeric phase. In the symbolic phase, the precise number of non-zeros in the output matrix is computed, while the real values are calculated in the numeric phase. This precise method is computationally expensive because of the non-trivial pre-computation of the actual number of non-zeros. As another example, an upper bound method computes an upper bound of the number of non-zeros in the output matrix. One of the methods for calculating an upper bound is to count the number of non-zeros of the corresponding row in one input matrix for each non-zero in the other input matrix. This upper bound method alone usually yields poor performance (e.g., extremely high memory consumption) for applications with a high compression ratio. Here, the “compression ratio” refers to a ratio between a number of multiplication operations to generate the output matrix and a number of non-zero elements in the generated output matrix. In many real-world applications, the non-zero elements in a sparse matrix may be irregularly generated.

To address the above-identified deficiencies of existing solutions, some solutions provide ways of more accurately estimating the memory footprint of the output matrix and directly allocating the memory space for the output matrix based on the estimation. However, the estimation is almost always different from the ground truth, which may lead to memory waste (if the solutions over-estimated the memory footprint of the output matrix) or expensive dynamic memory reallocation operations during runtime (if the solutions under-estimated the memory footprint of the output matrix).

The issue with the above estimation-based-output-matrix-memory-space-allocation solutions is that the estimation can rarely achieve 100% accuracy. The present disclosure describes a 100% accurate memory allocation method/hardware device, in which memory estimation is still a component of the process, but merely used to improve the symbolic computation efficiency rather than being used as the basis for the final memory allocation. Instead, the outcome of the improved symbolic computation (e.g., the accurate memory size of the output matrix) is used as the basis for the final memory allocation.

For easy understanding, several terms used in the following description are defined here.

FLOP may refer to the number of floating-point multiplication operations to be performed between each row in the first sparse matrix and one or more corresponding rows in the second sparse matrix to generate a row in the to-be-generated output matrix. For instance, when computing spGEMM between a first and a second sparse matrices to generate an output matrix, each row in the first sparse matrix (with non-zero data) may be multiplied with one or more rows in the second sparse matrix to generate a row in the to-be-generated output matrix. The number of multiplication operations to be performed in order to generate the row in the to-be-generated output matrix may be referred to as a FLOP corresponding to the output row in the output matrix. In some embodiments, the FLOP corresponding to one output row may be computed based on the number of non-zero data in the corresponding rows in the first and second sparse matrices. In this disclosure, floating-point multiplication is used as an example. In some embodiments, the multiplication operations may be based on integers or other types of data.

NNZ may refer to the number of non-zero elements in a row. NNZ of an output row in the output matrix may be determined before actually performing the numerical computation. The determination may involve performing symbolic computation based on the non-zero data in the first and second sparse matrices. Note that the NNZ of an output row is most likely smaller than FLOP for that output row. This is because multiple the multiplications (FLOP) may contribute to a same non-zero element in the output row. For this reason, FLOP of an output row may be referred to as the upper bound of NNZ of the output row.

Compression Ratio (CR) may refer to a ratio between FLOP and NNZ corresponding to one or more rows of the output matrix or FLOP/NNZ of the entire output matrix.

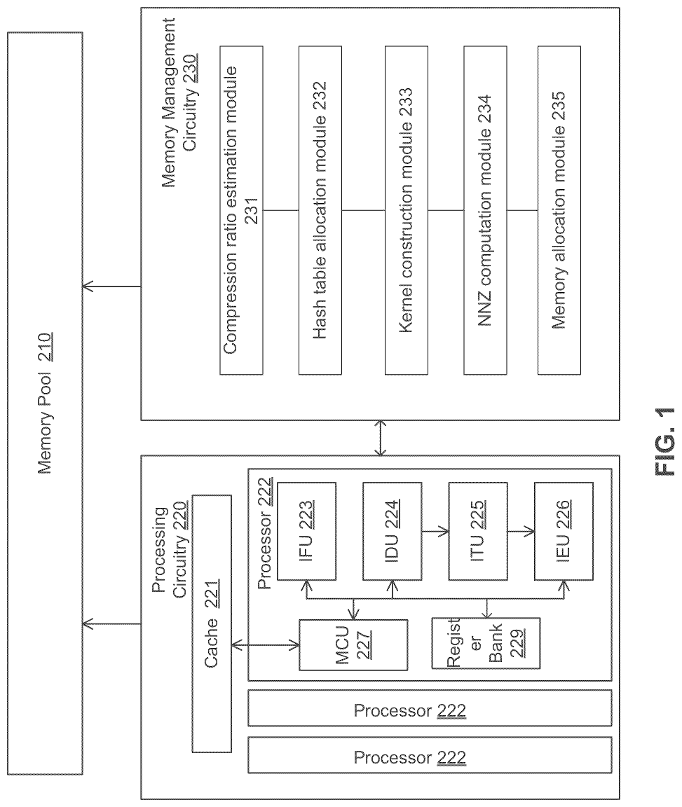

FIG. 1 illustrates an example schematic diagram of a hardware environment for implementing efficient memory allocation for spGEMM (General Sparse matrix-matrix Multiplication) in accordance with some embodiments.

As shown, the hardware environment in FIG. 1 includes a memory pool 210, a processing circuitry 220, and a memory management circuitry 230. The layout of the components in the hardware environment is for illustrative purposes, and may be implemented in different ways depending on the actual hardware configuration. In some embodiments, the memory management circuitry 230 may be implemented as a standalone hardware accelerator that is separated from the processing circuitry 220 (e.g., one or more CPUs or GPUs). In some embodiments, the memory management circuitry 230 may be implemented as a part of the processing circuitry 220 (e.g., a part of one or more CPUs or GPUs) to improve the efficiency of memory management. The memory pool 210 may refer to external storage devices, system RAM, other types of memory resources, or any combination thereof.

In some embodiments, the processing circuitry 220 may include one or more processors 222 and a cache 221 shared by the one or more processors 222. Each processor 222 may include an instruction fetching unit (IFU) 223, an instruction decoding unit (IDU) 224, an instruction transmitting unit (ITU) 225, and an instruction execution unit (IEU) 226.

In some embodiments, the IFU 223 may fetch to-be-executed instructions or data from the storage/memory pool 210 to a register bank 229. In some embodiments, the to-be-executed instructions or data can be fetched into the cache 221 and sent to the IFU 223 via microcontroller unit (MCU) 227. After obtaining the instructions or data, the processing circuitry 220 enters an instruction decoding stage. The IDU 224 decodes the obtained instruction according to a predetermined instruction format to determine operand(s) acquisition information, where the operands are required to execute the obtained instruction. In some embodiments, the operand(s) acquisition information may include pointers or addresses of immediate data, registers, or other software/hardware that provide the operand(s).

In some embodiments, the ITU 225 may be configured to receive the decoded instructions from the IDU 224 and perform instruction scheduling and management. It may efficiently allocate instructions to different IEUs 226 for parallel processing. In some embodiments, after the ITU 225 allocates an instruction to one IEU 226, the IEU 226 may execute the instruction.

In some embodiments, the memory management circuitry 230 may receive instructions from processing circuitry 220, access data from the memory pool 210, and perform local computations such as determining an estimated size of memory space for constructing hash tables, constructing kernels to perform symbolic computations using the hash tables, and determining the accurate size of memory space for storing the output matrix based on the symbolic computation results. The memory management circuitry 230 may send the memory sizes back to the processing circuitry 220 for actually applying or allocating the memory space, or directly trigger system calls to allocate the memory space accordingly.

In some embodiments, the memory management circuitry 230 may include an obtaining module (not shown in FIG. 1), a compression ratio estimation module 231, a hash table allocation module 232, a row grouping and kernel construction module 233, an NNZ computation module 234, and a memory allocation module 235. These modules may be implemented as electronic circuits including electronic components such as resistors, transistors, capacitors, inductors, and diodes, connected by conductive wires or traces through which electric current can flow. In other embodiments, these modules may be implemented by software controlling the data logic and flow among the electronic components. The modules in FIG. 1 are for illustrative purposes. Depending on the implementation, the memory management circuitry 230 may include fewer, more, or alternative modules.

In some embodiments, the obtaining module may be configured to obtain the two sparse matrices for spGEMM. For example, the non-zero elements in the two sparse matrices may be obtained from a storage place (e.g., a database storing the sparse matrices in a compact form). In some embodiments, each non-zero element may include a non-zero value and be associated with a row-column index pair (a row index and a column index may locate the non-zero value within the corresponding matrix). In some embodiments, only the non-zero elements of the sparse matrices are stored and the zero elements are ignored. The non-zero elements may be stored in a way that the corresponding index information are explicitly or implicitly stored along with the non-zero values.

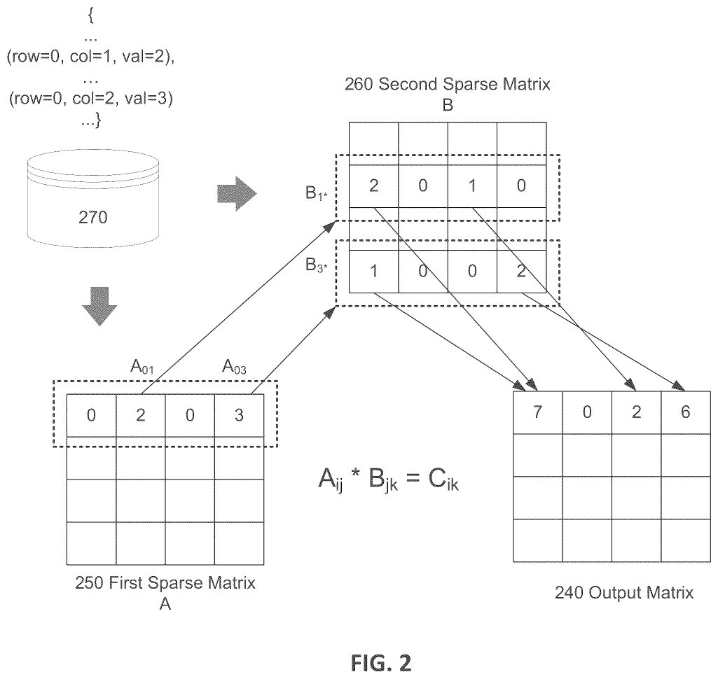

In some embodiments, the compression ratio estimation module 231 may be configured to estimate a compression ratio for the output matrix by performing symbolic computations on a small number of sampled first rows in the first sparse matrix and the corresponding second rows in the second sparse matrix. As explained above, the compression ratio may be estimated based on the FLOPs and NNZs of output rows corresponding to (i.e., generated based on) the sampled first rows. In other words, the estimation of the compression ratio may compute both FLOP and NNZs based on the plurality of first rows sampled from the first sparse matrix. For instance, after a subset of rows from the first sparse matrix are sampled, symbolic computations may be performed between the sampled rows and one or more corresponding rows in the second sparse matrix. The symbolic computations may include: (1) determining how many multiplication operations (FLOPs) need to be performed based on the sampled first rows to generate the corresponding output rows; and (2) determining NNZs in the to-be-generated output rows. These two steps may be implemented in various ways. For instance, when a row-based matrix multiplication (details in FIG. 2) is adopted, each sampled first row may multiply with one or more corresponding second rows in the second sparse matrix to generate one output row. In this case, the FLOP may be computed based on the number of non-zero elements in the one or more corresponding rows in the second sparse matrix (e.g., using a counter). As another example, the NNZ in each of the output rows corresponding to the sampled first rows may be computed by using hash tables to record the unique combinations of the row-column index information of the non-zero data in the sampled rows from the first sparse matrix and the row-column index information of the non-zero data in the corresponding second rows from the second sparse matrix. In summary, the FLOPs and the NNZs of the output rows may be calculated by different types of symbolic computations, in which the symbolic computations for calculating the NNZs include using hash tables to perform index deduplication, while the symbolic computations for calculating the FLOPs do not require deduplication.

After obtaining the estimated compression ratio, the NNZs for all rows (not just the ones corresponding to the sampled first rows) in the output matrix may be estimated based on the estimated compression ratio and the FLOPs corresponding to all rows in the output matrix. The estimated NNZs may be used by the hash table allocation module 232 to determine the sizes of memory spaces for allocating hash tables. These hash tables are important tools to compute the actual NNZs for all rows in the output matrix during the next round of symbolic computation, and the actual NNZs may provide the ground-truth memory sizes for storing the to-be-generated output matrix. In particular, symbolic computation on a row from the first sparse matrix and one or more corresponding rows from the second sparse matrix may store the unique row and/or column indices of non-zero output data in the corresponding hash table, thereby determining how many unique non-zero output data will be generated for the output row. During this process, each output row may be allocated a hash table so that all rows may be processed in parallel.

Allocating a proper size hash table is critical to achieve the optimal performance and memory resource utilization. In particular, the hash table may be used to store the unique data (e.g., unique row-column-indices) generated from the symbolic computation for a given output row. That means, every newly generated data needs to do a hash table collision check. If the indices of the newly generated data do not have a collision in the hash table, the indices of the newly generated data are written into the hash table because they are unique in the hash table. If the indices of the newly generate data have collisions in the hash table, more detailed and expensive collision handling need to be performed to determine whether the newly generated indices need to be stored in the hash table or not. For instance, if the hash function generates the same hash value for two different indices, then the newly generated index should be stored as it corresponds to a different data entry. During this process, the hash table size matters. A larger size hash table will yield less collisions but consume more memory spaces, while a smaller size hash table is more memory efficient but may cause more hash collisions and the expensive collision handlings.

In some embodiments, a first memory space may be allocated for each output row in the to-be-generated output matrix based on the corresponding estimated NNZ for that output row. The first memory space is used for constructing a hash table for the each output row. The hash table is then used for performing symbolic computation to determine the actual NNZ that will generated in the output row. In some embodiments, the hash table size may be determined by applying a floating scale factor greater than one (e.g., 2.5 or 3) to the estimated NNZ to obtain a scaled-up memory size. This scale factor is designed to control the collision rate at a desired percentage.

In some embodiments, the kernel construction module 233 may be configured to construct kernels to perform symbolic computations between the first and second sparse matrices using the constructed hash tables. Here, the “kernel” refers to a routine compiled for high throughput accelerators (such as graphics processing units (GPUs), digital signal processors (DSPs) or field-programmable gate arrays (FPGAs)), separate from but used by a main program (typically running on a central processing unit). For instance, the kernel may include a function executable by a GPU.

As explained above, different rows in the first sparse matrix (along with their corresponding rows in the second sparse matrix) may generate different NNZs in the corresponding output rows, thus may require different computing resource allocations, pipeline arrangement, failure recovery/error handling, etc. For instance, a first row may generate a large number of NNZs and thus the symbolic computation may be allocated a larger size hash table to avoid high collision rate, and a second row may generate a tiny number of NNZs and thus the symbolic computation may have a small size hash table to reduce the memory footprint. In this case, the kernels for performing symbolic computations on the different rows may be configured differently. For instance, these different kernels may be configured with different hash table sizes, create the hash tables in an on-chip shared memory or off-chip DRAM, use different thread block sizes or thread assignments (e.g., the number of threads for extracting an entire row of the second matrix), or even different computing algorithms, etc. In some embodiment, the rows in the first sparse matrix may be grouped into a plurality of row groups based on the corresponding output rows' estimated NNZs, and each row group may share a same kernel to reduce the kernel construction cost.

With the kernels constructed for the different groups, the NNZ computation module 234 may be configured to perform symbolic computation on each row using the corresponding hash table and corresponding kernel to determine the actual NNZ to be generated in a corresponding output row, but without actually performing the expensive numerical computations. The actual NNZs generated from the symbolic computations are the exact NNZs for all output rows. In summary, the sampled small number of rows are used to estimate the compression ratio; the compression ratio is used to estimate the NNZs for all output rows; the estimated NNZs for all output rows are used to estimate the hash table sizes for all rows; the hash tables are then be allocated for performing symbolic computations (one hash table may correspond to one or more output rows in the output matrix for performing the symbolic computations); the output of the symbolic computations include the actual NNZs for all rows; the actual NNZs may be used to determine the actual memory size of the output matrix (by merely performing symbolic computations without actually computing any numerical output data in the output matrix); and the actual memory size of the output matrix may be used for allocating the memory size to store the to-be-generated output matrix.

Note that the above row sampling & estimating NNZ steps are necessary to provide a fairly accurate hash table size estimation, so that the symbolic computation for determining the actual NNZs for all rows may less likely encounter hash collisions or waste memory resources.

In some embodiments, the memory allocation module 235 may be configured to allocate memory spaces for the output matrix of a spGEMM according to the exact NNZs from the symbolic computation. The memory space allocated may be a contiguous section of a hardware memory device for efficient sequential data access. The number of rows of the output matrix may be equal to the first input matrix of the spGEMM.

In some embodiments, the above-described hash table allocation step may further improve its efficiency by determining hash table sizes for groups of rows rather than individual rows. For instance, the hash table size constructions may occur after the rows are grouped into row groups based on corresponding estimated NNZs. For each row group, the largest NNZ may be selected as the basis for constructing the hash table. The floating scale factor greater than one (e.g., 2.5 or 3) may be applied to the largest NNZ to determine how many entries the hash table should be able to contain (i.e., the hash table size). Once the hash table size is determined, all the rows in the same row group will share the same the hash table size.

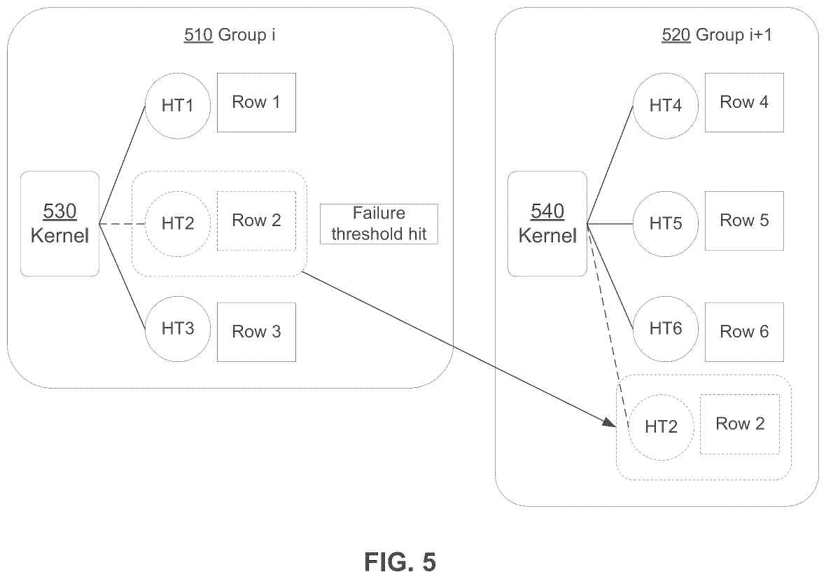

In some embodiments, the estimated hash table size may not be sufficiently large, which may lead to expensive hash table collision handling. To address this issue, the memory management circuitry 230 may include failure detection and error handling modules to early detect the hash table space shortage in any row, and proactively adjust the hash table sizes. In some embodiments, the hash table sizes (as well as kernel constructions) are determined based on row grouping results. When the failure detection and error handling modules detect that one row is experiencing insufficient hash table space, the row may be “promoted” from the current row group to a next row group, which corresponds to greater NNZs and a larger hash table size. FIG. 5 illustrates a detailed example of failure detection and error handling.

FIG. 2 illustrates an exemplary row-wise approach for executing spGEMM with efficient memory allocation in accordance with some embodiments. In some embodiments, the memory management circuitry in FIG. 1 relies on row-wise matrix multiplications, which is an approach that is different from a textbook row-column matrix multiplication.

As shown in FIG. 2, the spGEMM involves two sparse input matrices A 250 and B 260. These sparse matrices may be stored in a data repository 270 (e.g., a database, a cloud server) in a compact storage format, such as COO, CSR, bit maps, etc. These compact storage formats may only store the non-zero elements in the sparse matrices (along with their index information) to save storage space and facilitate access to non-zero elements. In some practical applications, the non-zero elements generated as part of the spGEMM using row-wise matrix multiplication may include a plurality of duplicated data entries. The term “duplicated data entries” refers to multiple values corresponding to the same row index and column index (also called a row-column index pair) in the output matrix and need to be aggregated to generate one output value.

In some embodiments, while reading the non-zero elements from the data repository 270, an iterative process of row-wise matrix multiplication may be performed. For example, the first row (row=0) of the first sparse matrix A 250 in FIG. 2 may include multiple non-zero elements (e.g., Aₒ₁ and A₀₃ at columns 1 and 3, respectively). For each of these non-zero elements, a corresponding row of the second sparse matrix B 260 may be obtained. The corresponding row from B may have a row index equal to the column index of the non-zero element of the corresponding rows in the first matrix. For instance, Aₒ₁ corresponds to row B_{1*} of matrix B, where B_{1*} represents all the non-zero elements of the row 1 of matrix B. The non-zero element from matrix A then may multiply with all non-zero elements in the corresponding row from B. For each multiplication between the element at (row=i, col=j) of matrix A and the element at (row=j, col=k) of matrix B, the resulting output value may be placed at a position (row=i, col=k) of an output matrix 240. This principle may be denoted as Aᵢⱼ*Bⱼₖ=Cᵢₖ. After processing all of the non-zero elements in the first row of matrix A, the next row of matrix A may be processed. In some embodiments, since the rows of the matrix A in the row-wise matrix multiplication may be processed independently, parallel processing techniques may be applied to improve the computation efficiency. When multiple processes are writing multiplication results into the same cell in the output matrix 240, these writes may be serialized using locking mechanisms.

With the above description, the difference between the textbook row-column matrix multiplication and the row-wise matrix multiplication becomes obvious. In the textbook row-column matrix multiplication, a row from a first matrix is multiplied with a corresponding column from a second matrix, and the multiplication results may be summed up to generate one output value in an output matrix. That is, in the textbook row-column matrix multiplication, each multiplication and the corresponding summation of the first row in the first matrix and the second column in the second matrix will generate one final output value for the output matrix. In contrast, row-wise approach involves multiplying a first row from the first matrix and a plurality of corresponding second rows from the second matrix in a plurality of execution cycles to generate an entire output row in the output result matrix. Each multiplication of the first row and one second row may generate one or more partial output values for a row of the output matrix. These partial output values generated from the plurality of multiplications during the plurality of execution cycles may be aggregated to generate the final output values for an output row. The row-wise matrix multiplication imposes new challenges that may not exist in traditional row-column matrix multiplication: the partial output values generated from different execution cycles may contribute to the same output value in the output matrix. These partial outputs may be referred to as duplicate intermediate products with the same row-column index pair in the output matrix.

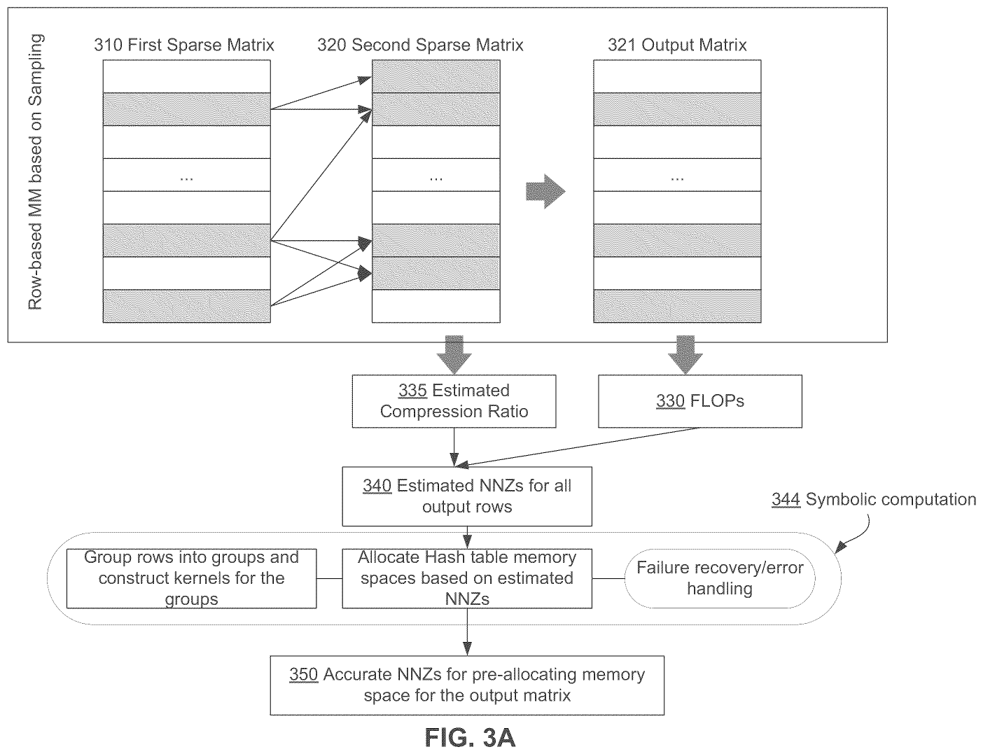

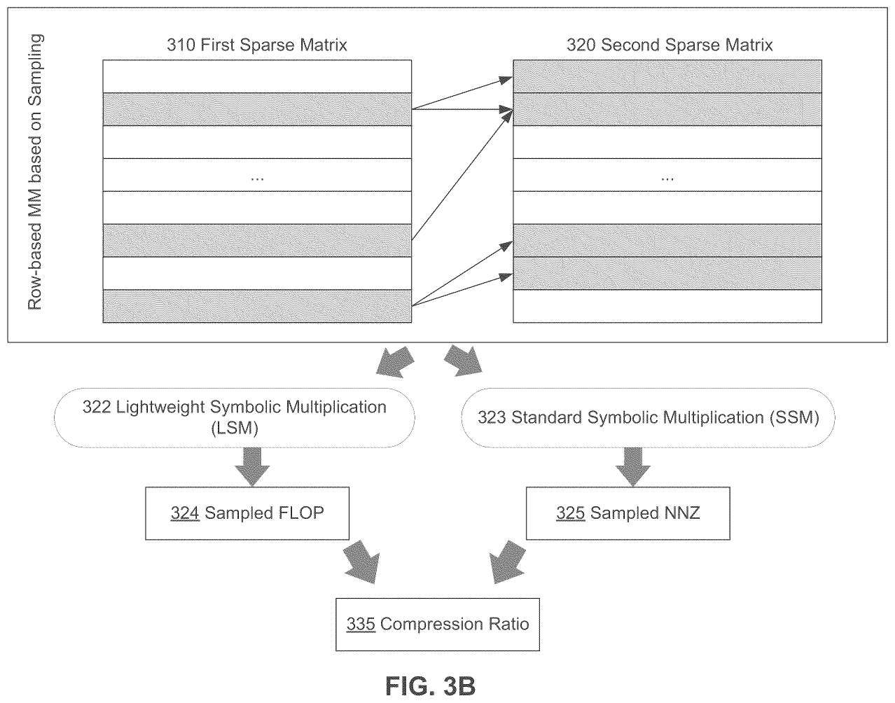

FIG. 3A illustrates an exemplary block diagram of efficient memory allocation for spGEMM in accordance with some embodiments. The diagram in FIG. 3A illustrates the efficient memory allocation process for spGEMM computations. The process may be implemented by the memory management circuitry 230 illustrated in FIG. 1.

In spGEMM, a first sparse matrix 310 and a second sparse matrix 320 may be multiplied to generate an output matrix 321 in a computer system. The computer system may need to allocate memory spaces for storing the output matrix 321. Allocating the memory space in real-time while the output matrix 321 is being computed is slow and costly. Thus, pre-allocating the memory space before actually computing the output matrix 321 is a more popular solution in the field. The system described in FIG. 1 may accurately determine the size of the output matrix 321 before actually performing the numerical computations based on the first and second sparse matrices. In particular, a multi-stage symbolic computation pipeline is designed to determine the NNZs in each row of the output matrix. This multi-stage symbolic computation may include a first stage for computing FLOPs, a second stage for computing accurate NNZs in output rows corresponding to sampled first rows (the accurate NNZs may then be used to determine estimated compression ratio, estimated NNZs for all output rows, and allocate corresponding hash tables), and a third stage for computing accurate NNZs for all output rows using the allocated hash tables.

During the third stage of symbolic computation, each row in the output matrix may have a corresponding hash table for storing the unique non-zero data generated so far. For instance, while iterating the non-zero data in the first row of the first sparse matrix 310, corresponding second rows in the second sparse matrix 320 may be identified, and the indices of non-zero data in these corresponding second rows may be obtained. The indices of the non-zero data in the first rows and the second rows may determine the indices of the output data. For instance, a non-zero data in the first row with indices (x, y) and a corresponding non-zero data in the second row with indices (y, z) will generate a data at (x, z) in the output matrix. The indices (x, z) of the newly generated data may be checked against the hash table to determine the uniqueness. If (x, z) has no collision in the hash table, the corresponding data is unique and the NNZ for the corresponding row should be increased. If (x, z) has a collision in the hash table, a collision handling procedure is executed to determine whether the collision is caused by the hash function or a repeated index pair. The chance of hash collision is directly affected by the fullness of the hash table.

Accordingly, the hash table sizes are critical for the symbolic computation. Oversized hash tables may cause memory resource waste, and undersized hash tables may lead to poor performance due to the expensive hash collision operations. FIG. 3A illustrates a process to properly estimate the hash table sizes. The estimation is based on performing symbolic computations on rows sampled from the first sparse matrix.

As shown in FIG. 3A, the grey rows in the first sparse matrix 310 may represent the sampled rows, and the grey rows in the second sparse matrix 320 may represent the rows that are corresponding to the sampled rows. The correspondence between the grey rows from the two matrices is represented with arrows. It may be noted that two different sampled rows from the first sparse matrix 310 may be mapped to the same row from the second sparse matrix 320. For clarity, the output rows in the output matrix 321 corresponding to the sampled rows in the first sparse matrix 310 may be referred to sampled output rows in the following description.

After obtaining the sampled rows from the first sparse matrix 310 and the corresponding rows from the second sparse matrix 320, the FLOPs 330 and NNZs for the sampled output rows (referring to the output rows corresponding to the sampled rows in the first sparse matrix 310) may be computed, and then an estimated compression ratio 335 for the output matrix may be determined based on the FLOPs 330 and the NNZs. The estimated compression ratio 335 may be computed as a ratio between the FLOPS of the sampled output rows and the NNZs of the sampled output rows. Here, the FLOPs 330 for the sampled output rows and the FLOPs for all other output rows may be obtained by performing a first type of symbolic computations (also called lightweight symbolic computation). The NNZs of the sampled output rows may include accurate NNZs of the sampled output rows obtained by performing a second type of symbolic computations (also called standard symbolic computation) on the sampled rows from the first and second matrices. The detailed explanation of the two types of symbolic computations may be found in FIG. 3B. With the estimated compression ratio 335 and the FLOPs of all output rows, all rows' estimated NNZs may be obtained by dividing FLOPs with the estimated compression ratio.

As shown in FIG. 3B and the analysis above, the estimated compression ratio 335 may be computed based on sampled FLOPs 324 and sampled NNZs 325, which may be respectively computed by using a lightweight symbolic multiplication (LSM) algorithm 322 and a standard symbolic multiplication algorithm (SSM) 323 based on the sampled rows from the first sparse matrix 310 and the corresponding rows from the second sparse matrix 320. In computing the sampled FLOP 324 and NNZ 325, both LSM 322 and SSM 323 avoid performing floating number multiplications and thus greatly save computing resources such as CPU cycles. Furthermore, both LSM 322 and SSM 323 work only on index information of the sampled rows and the corresponding rows rather than the actual non-zero floating-point values, which effectively reduces the volume of data to be read into the memory and processed. Therefore, LSM 322 and SSM 323 may save both computing resources and memory consumption in computing the sampled FLOP and NNZ in comparison to using numeric matrix multiplications to do so.

In some embodiments, after determining the corresponding rows from the second sparse matrix 320 that correspond to the sampled rows from the first sparse matrix 310, both SSM 323 and LSM 322 may be executed by merely relying on (1) the row indices of the sampled rows and (2) the column indices of the non-zero data in the plurality of corresponding rows. In some embodiments, SSM 323 may start with, for each sampled row in the first sparse matrix 310, retrieving index information of non-zero data in one or more corresponding rows (the rows from the second sparse matrix 320 that correspond to the sampled row). Here, the index information of the corresponding rows may be conveniently read from the CSR format of the second sparse matrix 320. The index information to be read from the CSR format may be further trimmed to just the column indices of the non-zero data. SSM 323 may then iterate through the column indices of the non-zero data and input the column indices into a data structure for detecting and removing duplicated values. The data structure may refer to set, list, hash table, hash list, or another suitable data structure depending on the implementation. With the data structure, SSM 323 may determine a number of unique column indices from the column indices of the non-zero data in the one or more corresponding rows. The above steps may be repeated until all sampled rows are processed. The number of unique column indices determined for each sampled row may be accumulated to obtain the sampled NNZ 325.

In some embodiments, LSM 322 may be a simplified (more lightweight) version of SSM 323 without performing the column index deduplication step. For instance, LSM 322 may include: for each sampled row, retrieving index information of non-zero data in one or more corresponding rows (the rows from the second sparse matrix 320 that correspond to the sampled row), and determining a number of non-zero data in the one or more corresponding rows based on the index information (each of the indices corresponding to a non-zero value). This determined number of non-zero data may be accumulated to obtain the final FLOPs for the sampled row. In CSR format, the number of non-zero data may be directly obtained without retrieving the index information. The above steps may be repeated until all sampled rows are processed.

With the FLOPs and NNZs for the output rows corresponding to the sample rows, the compression ratio 335 may be computed accordingly. Here, it is assumed that all the rows in output matrix share the same compression ratio 335. The computation of the compression ratio 335 may be implemented in various ways. For instance, the FLOPs of the sampled output rows may be summed as a total FLOP, and the NNZs of the sampled output rows may be summed as a total NNZ. The compression ratio may be computed as a ratio between the total FLOP and the total NNZ.

Referring back to FIG. 3A, after obtaining the estimated compression ratio 335, NNZs for all output rows 340 may be estimated. For instance, the estimated NNZ for a given row may be computed by multiplying the reciprocal of the estimated compression ratio 335 with the corresponding FLOP of the given row.

After obtaining the estimated NNZs for all rows 340, symbolic computation 344 may be executed to determine the actual NNZs for all rows in order to pre-allocate memory space for the output matrix based on the actual NNZs. During the symbolic computation, the estimated NNZs for all output rows 340 may be used in two ways to improve the performance and resource utilization of the symbolic computation 344.

First, the estimated NNZs may be used to estimate the hash table sizes for symbolic computation. As described above, symbolic computation involves checking the uniqueness of a given index pair (the index of a potential non-zero data in the output matrix) using a hash table, and allocating a properly sized hash table is critical for the performance of the symbolic computation. In some embodiments, the estimated NNZ for a row may be scaled up by a factor (e.g., 2.5 or 3.5) to obtain the estimated number of entries to be held in the hash table (i.e., the hash table size).

Second, the estimated NNZs for all output rows 340 may allow programmers to customize symbolic computation kernels with a fine granularity, rather than applying a universal kernel for all rows. These fine-tuned kernels may be specifically designed for rows that are generating NNZs within a certain range. In some embodiments, the rows may be clustered into groups according to corresponding estimated NNZs, and different kernels may be specifically tailored for different groups according to the estimated NNZs of the rows therein with failure recovery and error handling mechanisms. For instance, the kernels for different groups may have different failure thresholds for the hash tables to trigger failure recovery or error handling procedures. The failure threshold of a given hash table refers to a fullness threshold of the hash table. When the hash table reaches the fullness threshold during the symbolic computation for a corresponding row, it may be determined as lacking sufficient space for continuing the symbolic computation. It means, the hash table size determined based on the row's estimated NNZ (and the scale-up factor) is insufficient. Example usage of a failure threshold may include: for a row in the row group, determining a failure threshold based on a size of the hash table corresponding to the row; detecting that the symbolic computation on the row generates a number of non-zero data greater than the failure threshold; and raising an exception comprising an index of the row, wherein the exception triggers an error handling procedure. FIG. 5 illustrates an example of error handling procedure in response to the failure threshold being triggered.

After the symbolic computation on all rows in the first sparse matrix 310 is complete without raising any exception, the accurate NNZs 350 of the rows in the output matrix may be determined and used for pre-allocating the memory space for the output matrix. Note that until this point, only the symbolic computations are performed, and the resource-intensive numerical computation of the spGEMM is not executed yet. After the memory space for the output matrix is allocated, the spGEMM may proceed with the numerical computation and store the actual numerical output values in the output matrix memory space.

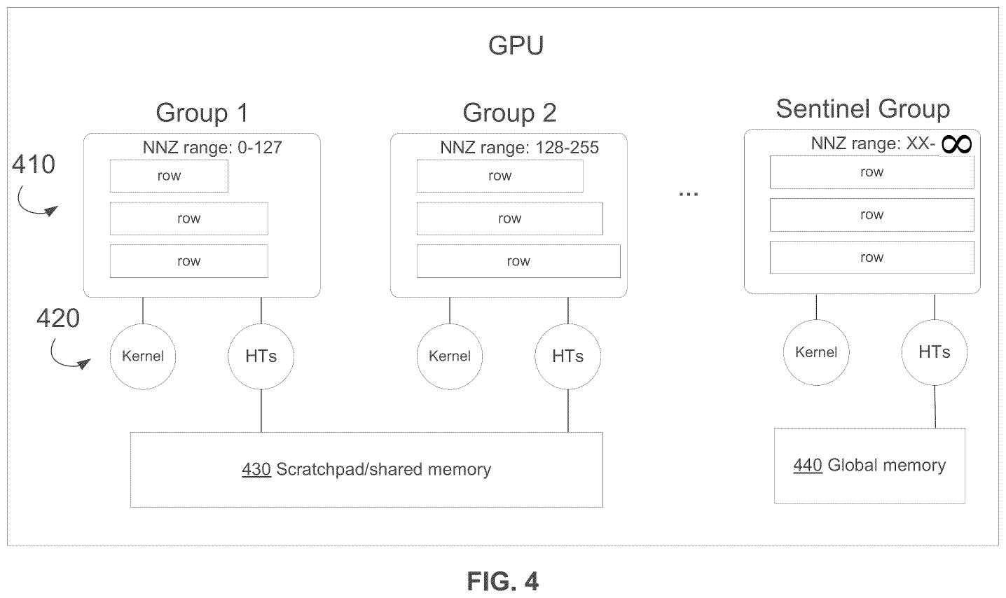

FIG. 4 illustrates an exemplary diagram for constructing kernels and allocating hash tables in computing the memory size for storing the output matrix of the spGEMM in accordance with some embodiments. After obtaining the estimated NNZs for all the output rows, the corresponding rows in the first sparse matrix may be grouped into row groups 410 based on the estimated NNZs. For instance, as shown in FIG. 4, group 1 includes all rows generating NNZs between 0 and 127, group 2 includes all rows generating NNZs between 128 and 255, and so on. The group with a higher NNZ range may allocate a larger hash table for the rows it contains. In some embodiments, the groups may include a special fallback group, called a sentinel group, to include all rows that do not fit in any preceding groups. Here, the concept of “fit” refers to whether sufficient hash table memory space is allocated. In one embodiment, all row groups except for the sentinel group may have their corresponding hash tables allocated from a scratchpad or shared memory 430 in a GPU, whereas the sentinel group may have its hash tables allocated from a global memory 440 of the GPU. In GPUs, shared memory 430 is on-chip and implemented with SRAM while global memory 440 is implemented with DRAM. Shared memory 430 is much faster than the global memory 440. Shared memory 430 is allocated per thread block, so all threads in the block have access to the same shared memory 430. Threads can access data in shared memory 430 loaded from global memory 440 by other threads within the same thread block. The shared memory may be limited in size in comparison with the global memory.

After grouping the rows into the row groups 410, different kernels 420 may be constructed for different row groups by taking into account the estimated NNZs to be generated from the rows. Different NNZs to be generated may affect various configurations of the kernels, such as failure thresholds. In some embodiments, the rows within the same group may share the same hash table size. For instance, the hash table size may be determined by applying a scale-up factor to the largest NNZ of the rows in the row group.

FIG. 5 illustrates an exemplary error handling procedure in computing the output matrix size of the spGEMM in accordance with some embodiments. The error handling procedure illustrated in FIG. 5 may be triggered when a failure threshold of a hash table is hit. As shown, a kernel 530 is executing symbolic computations on the rows in group i 510. Each row in group i has a hash table as part of the symbolic computation. The computation keeps discovering new non-zero data indices and adds to the hash table. The indices having hash collisions in the hash table may be deemed as duplicate entries and abandoned (i.e., not a new non-zero data but a partial sum to be added to an existing non-zero data). The indices not having hash collisions may be added into the hash table. When the hash table receives a number of indices that reaches the failure threshold, subsequent accesses to the hash table may experience a high rate of collisions and thereby causing performance degradation. Thus, the particular row corresponding to the hash table may be “promoted” to group i+1 520. Because the NNZ range for group i+1 520 is greater than the NNZ range for group I 510, the row promoted to group i+1 520 will be allocated a larger hash table to avoid a high collision rate. This promotion process may be repeated across multiple groups. The existence of the sentinel group (shown in FIG. 4) guarantees that, in the worst case, the row will have its hash table allocated from the global memory with sufficiently large memory space.

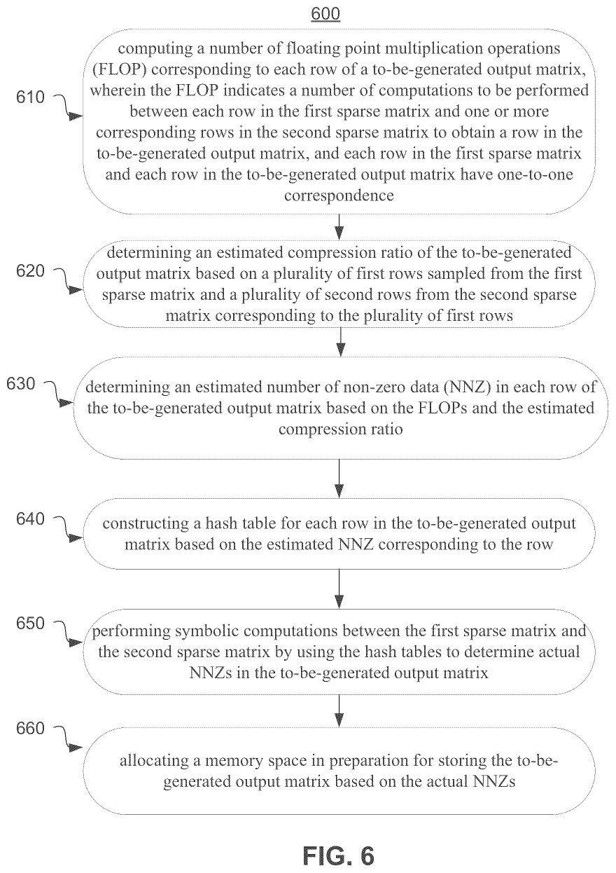

FIG. 6 illustrates an exemplary method 600 of efficient memory allocation for spGEMM in accordance with some embodiments. The method 600 may be implemented in an environment shown in FIG. 1. The method 600 may be performed by a device, apparatus, or system illustrated by FIGS. 1-5, such as the memory management circuitry 230 in FIG. 1. Depending on the implementation, the method 600 may include additional, fewer, or alternative steps performed in various orders or parallel.

Block 610 includes computing a number of floating point multiplication operations (FLOP) corresponding to each row of a to-be-generated output matrix, wherein the FLOP indicates a number of computations to be performed between each row in the first sparse matrix and one or more corresponding rows in the second sparse matrix to obtain a row in the to-be-generated output matrix, and each row in the first sparse matrix and each row in the to-be-generated output matrix have one-to-one correspondence.

Block 620 includes determining an estimated compression ratio of the to-be-generated output matrix based on a plurality of first rows sampled from the first sparse matrix and a plurality of second rows from the second sparse matrix corresponding to the plurality of first rows.

Block 630 includes determining an estimated number of non-zero data (NNZ) in each row of the to-be-generated output matrix based on the FLOPs and the estimated compression ratio.

Block 640 includes constructing a plurality of hash tables for rows in the to-be-generated output matrix based on the estimated NNZs corresponding to the rows.

Block 650 includes performing symbolic computations between the first sparse matrix and the second sparse matrix by using the plurality of hash tables to determine actual NNZs in the to-be-generated output matrix.

Block 660 includes allocating a memory space in preparation for storing the to-be-generated output matrix based on the actual NNZs.

In some embodiments, the method 600 may further include performing numeric computations based on non-zero data in the first sparse matrix and the second sparse matrix to obtain output data; and storing the output data in the memory space of the output matrix.

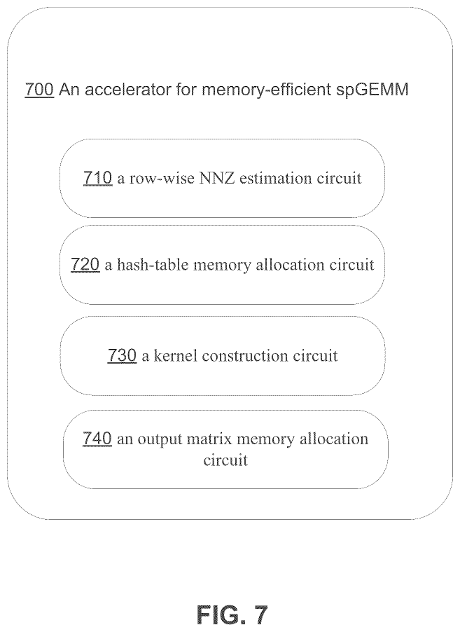

FIG. 7 illustrates an exemplary block diagram of a hardware device 700 with built-in efficient memory allocation for spGEMM in accordance with some embodiments. The components of the hardware device 700 presented below are intended to be illustrative. Depending on the implementation, the hardware device 700 may include additional, fewer, or alternative components.

The hardware device 700 may be an example of implementing the method 600 of FIG. 6 for efficient memory allocation in spGEMM between a first sparse matrix and a second sparse matrix. The hardware device 700 may include one or more processors and one or more non-transitory computer-readable storage media (e.g., one or more memories) coupled to the one or more processors and configured with instructions executable by the one or more processors to cause the system or device (e.g., the processor) to perform the above-described embodiments. The hardware device 700 may include various units/modules corresponding to the instructions (e.g., software instructions). In some embodiments, the hardware device 700 may include a device, apparatus, system, circuitry, or module illustrated by FIGS. 1-5, such as the memory management circuitry 230 in FIG. 1. The hardware device 700 may be implemented as part of a processing unit such as a CPU or GPU, or as a separate hardware accelerator.

In some embodiments, the hardware device 700 may include a row-wise NNZ (a number of non-zero data in each row) estimation circuit 710, a hash-table memory allocation circuit 720, a kernel construction circuit 730, and an output matrix memory allocation circuit 740.

In some embodiments, the row-wise NNZ estimation circuit 710 may be configured to compute a number of floating point multiplication operations (FLOP) to be performed between each row in the first sparse matrix and one or more corresponding rows in the second sparse matrix to generate a row in the output matrix, wherein each row in the first sparse matrix and each row in the output matrix have one-to-one correspondence; determine an estimated compression ratio based on a plurality of first rows sampled from the first sparse matrix and a plurality of second rows from the second sparse matrix corresponding to the plurality of first rows; and for each row in the first sparse matrix, determine an estimated number of non-zero data (NNZ) to be generated in the corresponding row in the output matrix based on the FLOPs and the estimated compression ratio.

In some embodiments, the hash-table memory allocation circuit 720 may be configured to construct a hash table for each row in the output matrix based on the estimated NNZ corresponding to the row. In some embodiments, the kernel construction circuit 730 may be configured to group rows in the first sparse matrix into a plurality of row groups based on the estimated NNZs; construct a plurality of kernels respectively for the plurality of row groups according to the estimated NNZs corresponding to the rows in each of the plurality of row groups; and for each of the plurality of row groups, perform, using the kernel, symbolic computation on the rows in the row group using the hash tables to determine actual NNZs in the output matrix.

In some embodiments, the output matrix memory allocation circuit 740 may be configured to allocate a memory space for storing the output matrix based on the actual NNZs.

Each process, method, and algorithm described in the preceding sections may be embodied in, and fully or partially automated by, code modules executed by one or more computer systems or computer processors comprising computer hardware. The processes and algorithms may be implemented partially or wholly in application-specific circuitry.

When the functions disclosed herein are implemented in the form of software functional units and sold or used as independent products, they can be stored in a processor executable non-volatile computer-readable storage medium. Particular technical solutions disclosed herein (in whole or in part) or aspects that contribute to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, where the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of example methods described herein may be performed, at least partially, by an algorithm. The algorithm may include program codes or instructions stored in a memory (e.g., a non-transitory computer-readable storage medium described above). Such an algorithm may comprise a machine learning algorithm. In some embodiments, a machine learning algorithm may not explicitly program computers to perform a function but can learn from training data to make a prediction model that performs the function.

The various operations of example methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or sections of code that include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. A computer-implemented method for memory allocation in performing sparse matrix-matrix multiplications (spGEMM) between a first sparse matrix and a second sparse matrix, comprising:
computing a number of floating point multiplication operations (FLOP) corresponding to each row of a to-be-generated output matrix, wherein the FLOP indicates a number of computations to be performed between each row in the first sparse matrix and one or more corresponding rows in the second sparse matrix to obtain a row in the to-be-generated output matrix, and each row in the first sparse matrix and each row in the to-be-generated output matrix have one-to-one correspondence;
determining an estimated compression ratio of the to-be-generated output matrix based on a plurality of first rows sampled from the first sparse matrix and a plurality of second rows from the second sparse matrix corresponding to the plurality of first rows;
determining an estimated number of non-zero data (NNZ) in each row of the to-be-generated output matrix based on the FLOPs and the estimated compression ratio;
constructing a plurality of hash tables for rows in the to-be-generated output matrix based on the estimated NNZs corresponding to the rows;
performing symbolic computations between the first sparse matrix and the second sparse matrix by using the plurality of hash tables to determine actual NNZs in the to-be-generated output matrix; and
allocating a memory space in preparation for storing the to-be-generated output matrix based on the actual NNZs.

2. The computer-implemented method of claim 1, wherein the FLOP indicates a number of multiplication operations to be performed to generate each row in the to-be-generated output matrix, and the FLOPs of output rows corresponding to the plurality of sampled first rows are denoted as sampled FLOPs, and
wherein the determining of the estimated compression ratio of the to-be-generated output matrix comprises:
computing actual NNZs for rows in the to-be-generated output matrix that correspond to the plurality of first rows sampled from the first sparse matrix as sampled NNZs; and
computing the estimated compression ratio of the to-be-generated output matrix as a ratio between the sampled FLOPs and the sampled NNZs for the rows in the to-be-generated output matrix that correspond to the plurality of first rows sampled from the first sparse matrix.

3. The computer-implemented method of claim 1, further comprising:
performing numeric computations based on non-zero data in the first sparse matrix and the second sparse matrix to obtain output data; and
storing the output data in the allocated memory space.

4. The computer-implemented method of claim 1, wherein the performing symbolic computations between the first sparse matrix and the second sparse matrix using the hash tables comprises:
grouping rows in the first sparse matrix into a plurality of row groups based on the estimated NNZs of the corresponding rows in the to-be-generated output matrix;
constructing a plurality of kernels respectively for the plurality of row groups; and
for each of the plurality of row groups, performing, using the kernel, symbolic computation using the hash tables to determine the actual NNZs in the to-be-generated output matrix.

5. The computer-implemented method of claim 4, wherein the kernels for different row groups are optimized differently according to the estimated NNZs corresponding to the rows in the different row groups.

6. The computer-implemented method of claim 1, wherein the FLOPs of output rows corresponding to the plurality of sampled first rows are denoted as sampled FLOPs, and the determining the estimated compression ratio comprises:
performing symbolic computation on each of the plurality of sampled first rows and one or more corresponding second rows in the second sparse matrix to obtain sampled NNZs; and
determining the estimated compression ratio based on the sampled FLOPs of output rows corresponding to the plurality of sampled first rows and the sampled NNZs.

7. The computer-implemented method of claim 1, wherein the constructing the plurality of hash tables for the rows in the to-be-generated output matrix based on the estimated NNZs comprises:
applying a floating scale factor greater than one to the estimated NNZ to obtain a scaled-up memory size;
allocating a first memory space based on the scaled-up memory size; and
constructing the hash table using the first memory space.

8. The computer-implemented method of claim 4, wherein the performing symbolic computation to determine the actual NNZs in the to-be-generated output matrix comprises:
for a row in the row group, determining a failure threshold;
detecting that the symbolic computation on the row generates a number of non-zero data greater than the failure threshold; and
raising an exception comprising an index of the row, wherein the exception triggers an error handling procedure.

9. The computer-implemented method of claim 8, wherein the error handling procedure comprises:
removing, based on the index of the row, the row from the row group and adding the row to a next group corresponding to greater estimated NNZs.

10. The computer-implemented method of claim 4, wherein the constructing the plurality of hash table to determine the actual NNZs in the to-be-generated output matrix comprises:
after grouping the rows in the first sparse matrix into the plurality of row groups, for rows in a same row group, obtaining the estimated NNZs of the corresponding rows in the to-be-generated output matrix;
determining a largest estimated NNZ in the same row group;
allocating a first memory space based on the largest estimated NNZ corresponding to each row in the same row group; and
constructing the plurality of hash tables for the corresponding rows in the to-be-generated output matrix row using the allocated first memory spaces.

11. The computer-implemented method of claim 10, wherein the first memory spaces corresponding to rows in a last row group are allocated from a global memory of a graphic processing unit (GPU), and the first memory spaces corresponding to rows other than the last row group are allocated from a shared memory of the GPU.

12. The computer-implemented method of claim 4, wherein each kernel includes a function executable by a GPU.

13. An sparse matrix-matrix multiplications (spGEMM) accelerator for allocating memory space to store an output matrix of sparse matrix-matrix multiplications (spGEMM) between a first sparse matrix and a second sparse matrix, comprising:
a row-wise NNZ (a number of non-zero data in each row) estimation circuit, configured to:
compute a number of floating point multiplication operations (FLOP) corresponding to each row of a to-be-generated output matrix, wherein the FLOP indicates a number of computations to be performed between each row in the first sparse matrix and one or more corresponding rows in the second sparse matrix to obtain a row in the to-be-generated output matrix, and each row in the first sparse matrix and each row in the to-be-generated output matrix have one-to-one correspondence;
determine an estimated compression ratio of the to-be-generated output matrix based on a plurality of first rows sampled from the first sparse matrix and a plurality of second rows from the second sparse matrix corresponding to the plurality of first rows;
determining an estimated number of non-zero data (NNZ) in each row of the to-be-generated output matrix based on the FLOPs and the estimated compression ratio;
a hash-table memory allocation circuit, configured to:
construct a plurality of hash tables for rows in the to-be-generated output matrix based on the estimated NNZs corresponding to the rows;
a kernel construction circuit, configured to:
group rows in the first sparse matrix into a plurality of row groups based on the estimated NNZs of the corresponding rows in the to-be-generated output matrix;
construct a plurality of kernels respectively for the plurality of row groups according to the estimated NNZs corresponding to the rows in each of the plurality of row groups;
for each of the plurality of row groups, perform, using the kernel, symbolic computation using the plurality of hash tables to determine NNZs in the to-be-generated output matrix; and
an output matrix memory allocation circuit, configured to:
allocate a memory space for storing the to-be-generated output matrix based on the determined NNZs in the to-be-generated output matrix.

14. The spGEMM accelerator of claim 13, further comprising:
a computing circuit, configured to:
perform numeric computations based on non-zero data in the first sparse matrix and the second sparse matrix to obtain output data; and
store the output data in the memory space of the output matrix.

15. The spGEMM accelerator of claim 13, wherein the row-wise NNZ estimation circuit is further configured to:
perform symbolic computation on each of the plurality of sampled first rows and one or more corresponding second rows in the second sparse matrix to obtain the FLOPs and NNZs for output rows corresponding to the sampled first rows; and
determine the estimated compression ratio based on the FLOPs and the NNZs for output rows corresponding to the sampled first rows.

16. The spGEMM accelerator of claim 13, wherein the row-wise NNZ estimation circuit is further configured to:
apply a floating scale factor greater than one to the estimated NNZ to obtain a scaled-up memory size; and
allocate the first memory space based on the scaled-up memory size.

17. The spGEMM accelerator of claim 13, wherein the kernel construction circuit is further configured to:
for a row in the row group, determine a failure threshold;
detect that the symbolic computation on the row generates a number of non-zero data greater than the failure threshold; and
raising an exception comprising an index of the row.

18. A non-transitory computer-readable storage medium for allocating memory space to store an output matrix of sparse matrix-matrix multiplications (spGEMM) between a first sparse matrix and a second sparse matrix, the storage medium storing instructions that, when executed by one or more processors, cause the one or more processors to perform operations comprising:
computing a number of floating point multiplication operations (FLOP) corresponding to each row of a to-be-generated output matrix, wherein the FLOP indicates a number of computations to be performed between each row in the first sparse matrix and one or more corresponding rows in the second sparse matrix to obtain a row in the to-be-generated output matrix, and each row in the first sparse matrix and each row in the to-be-generated output matrix have one-to-one correspondence;
determining an estimated compression ratio of the to-be-generated output matrix based on a plurality of first rows sampled from the first sparse matrix and a plurality of second rows from the second sparse matrix corresponding to the plurality of first rows;
determining an estimated number of non-zero data (NNZ) in each row of the to-be-generated output matrix based on the FLOPs and the estimated compression ratio;
constructing a plurality of hash tables for rows in the to-be-generated output matrix based on the estimated NNZs corresponding to the rows;
performing symbolic computations between the first sparse matrix and the second sparse matrix by using the plurality of hash tables to determine actual NNZs in the to-be-generated output matrix; and
allocating a memory space in preparation for storing the to-be-generated output matrix based on the actual NNZs.

19. The non-transitory computer-readable storage medium of claim 18, wherein the operations further comprise:
performing numeric computations based on non-zero data in the first sparse matrix and the second sparse matrix to obtain output data; and
storing the output data in the second memory space of the output matrix.

20. The non-transitory computer-readable storage medium of claim 18, wherein the performing symbolic computations between the first sparse matrix and the second sparse matrix using the plurality of hash tables comprises:
grouping rows in the first sparse matrix into a plurality of row groups based on the estimated NNZs of the corresponding rows in the to-be-generated output matrix;
constructing a plurality of kernels respectively for the plurality of row groups; and
for each of the plurality of row groups, performing, using the kernel, symbolic computation using the plurality of hash tables to determine the actual NNZs in the to-be-generated output matrix.
